(19) United States
(12) Patent Application Publication
(10) Pub. No.: US 2010/0115145 A1
(43) Pub. Date: May 6, 2010

(54) PLUG-AND-PLAY DEVICE AND METHOD OF USING THE SAME

(75) Inventors: SHYMMON BANERJEE, Calgary (CA); DOUGLAS BLAIR HILL, Calgary (CA); DAVID LABINE, Calgary (CA); MARK MCELHINNEY, Calgary (CA); VAUGHN KEENAN, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary (CA)

(21) Appl. No.: 12/611,408

(22) Filed: Nov. 3, 2009

Related U.S. Application Data
(63) Continuation of application No. 12/407,994, filed on Mar. 20, 2009.
Application No. 12/407,994 is a continuation-in-part of application No. 11/420,600, filed on May 26, 2006.

(51) Int. Cl. G06F 3/00; G06F 15/16

(52) U.S. Cl. 710/10; 709/228

(57) ABSTRACT

A plug-and-play device comprises a first plug-and-play interface for establishing a connection with a first computing device and a second plug-and-play interface for establishing a connection with a second computing device. Storage stores code that is automatically executed by the second computing device when the plug-and-play device is connected to the second computing device via the second plug-and-play interface. The code when executed by the second computing device initiates a screen display data exchange between the first and second computing devices through the plug-and-play device. A controller controls the first plug-and-play interface, the second plug-and-play interface and the storage.

### RELATED APPLICATIONS

The subject application is a continuation of U.S. patent application Ser. No. 12/407,994 to Banerjee, et al. filed on Mar. 20, 2009 for an invention entitled “Plug-And-Play Device And Method Of Using The Same”, which is a continuation-in-part of U.S. patent application Ser. No. 11/420,600 to Hill et al. filed on May 26, 2006 for an invention entitled “Plug-And-Play Device And Method Of Using The Same”, the contents of both incorporated herein by reference.

### FIELD

The subject application relates generally to computer peripheral devices and, more specifically, to a plug-and-play device and a method of using the same.

### BACKGROUND

Plug-and-play devices are well known and many types of plug-and-play standards exist, including for example universal serial bus (“USB”), IEEE1394 (“FireWire”) and PCMCIA (“PC Card”), with the most common being USB. Such plug-and-play devices have a set of functionality that is accessible to a computer through a plug-and-play interface. The functionality of common plug-and-play devices can include, but is not limited to, storage, input registration, image capturing, audio input and output, etc. The sets of functionality available on common plug-and-play devices are pre-defined as device classes. Upon connection of a plug-and-play device to a computer, an electronic circuit is completed and the operating system of the computer is alerted to the connection. The operating system in response polls the plug-and-play device to determine what functionality is available on the plug-and-play device.

Many operating systems possess a number of pre-loaded drivers for generic plug-and-play device classes, such as USB mass storage, a two-button mouse, etc. If the operating system is in possession of a driver for the device class of the plug-and-play device connected to the computer, the computer loads the driver so that the functionality of the plug-and-play device can be accessed by the computer. If the operating system does not possess a driver corresponding to the device class of the plug-and-play device, the operating system typically prompts the user to install the appropriate software to enable the computer to access the functionality of the plug-and-play device.

U.S. Patent Application Publication No. 2004/0205778 to Wong et al. discloses a peripheral device that includes driver storage. The peripheral device connects to a computer via a plug-and-play interface and cycles through the emulation of a number of plug-and-play device classes recognized by the operating system until one is found that permits auto-execution of a driver installation program.

U.S. Patent Application Publication No. 2005/0038934 to Gotze et al. discloses a USB-based peripheral printer that can be conditioned between two modes. In a first mode, the printer emulates USB mass storage to permit installation of drivers stored in memory of the printer on a computer to which the printer is connected. Once the drivers are installed on the computer, the printer is conditioned to a second mode, in which the printer behaves as a printer.

The need to install software/drivers can be undesirable in a number of situations, such as where a user does not possess administrative rights for the computer or simply does not desire to install yet more software on the computer, especially where connection of the plug-and-play device to the computer is infrequent or a one-time affair. Installing software may also prove to be a difficult or complicated task. For example, the user may need to download software from the Internet or may need to locate media upon which the software/drivers are located.

When the plug-and-play device is a touch panel, calibration to map the coordinate system of the input field of the touch panel to the display coordinate system of the computer to which the plug-and-play device is connected is typically required in order to ensure proper registration of touch input. Following the calibration process, the calibration settings are registered and stored by the computer. Unfortunately, because the computer stores the calibration settings, when the touch panel is plugged into a computer to which it was not previously connected, the calibration process must be carried out again in order to establish the calibration settings on the new computer.

### SUMMARY

Accordingly, in one aspect there is provided a plug-and-play device comprising: a first plug-and-play interface for establishing a connection with a first computing device; a second plug-and-play interface for establishing a connection with a second computing device; storage storing code that is automatically executed by the second computing device when said plug-and-play device is connected thereto via said second plug-and-play interface, said code when executed initiating a screen display data exchange between said first and second computing devices; and at least one controller controlling said first plug-and-play interface, said second plug-and-play interface and said storage.

In one embodiment, the first plug-and-play interface comprises a wireless transceiver and establishes a wireless connection with the first computing device. The wireless connection may be a secure wireless connection. In this case, the storage further stores at least one of at least one key, at least one biometric and at least one code that is used to establish the secure wireless connection. The plug-and-play device further comprises a physical connection to the second computing device. The physical connection may be in the form of a universal serial bus cable or the plug-and-play device may be configured as a dongle.

In another embodiment, the plug-and-play device comprises a physical connection to the first computing device and a physical connection to the second computing device. Each physical connection may be in the form of a universal serial bus cable.

The screen display data exchange may comprise transmission of second computing device display screen data to the first computing device. The second computing device display screen data is compressed prior to transmission to the first computing device. Differences between previously transmitted second computing device display screen data and current second computing device display screen data are transmitted. The code when executed may also permit file sharing between the first and second computing devices through the plug-and-play device.

The screen display data exchange alternatively may comprise transmission of first computing device display screen data to the second computing device. Similarly, the first computing device display screen data is compressed prior to transmission to the second computing device. Differences between previously transmitted first computing device display screen data and current first computing device display screen data are transmitted.

### BRIEF DESCRIPTION OF THE DRAWINGS

Embodiments will now be described with reference to the accompanying drawings in which:

FIG. 1 shows a plug-and-play device comprising a touch panel, a controller and a cable, coupled to a computer;

FIG. 2 is a schematic diagram of the cable of FIG. 1;

FIG. 3 is a flow chart of the general operation of the plug-and-play device of FIG. 1;

FIG. 4 shows another plug-and-play device allowing for screen sharing between a master computer and a remote computer;

FIG. 5 is a schematic diagram of the plug-and-play device of FIG. 4;

FIG. 6 is a flow chart of the general operation of the plug-and-play device of FIG. 4;

FIG. 7 shows the plug-and-play device of FIG. 4 with a touch panel and projector communicating with the master computer;

FIG. 8 shows yet another plug-and-play device allowing for bi-direction screen sharing between a master computer and a remote computer;

FIG. 9 is a schematic diagram of the plug-and-play device of FIG. 8;

FIG. 10 is a flow chart of the general operation of the plug-and-play device of FIG. 8; and

FIG. 11 shows the plug-and-play device of FIG. 8 with a touch panel and projector communicating with the master computer.

### DETAILED DESCRIPTION OF THE EMBODIMENTS

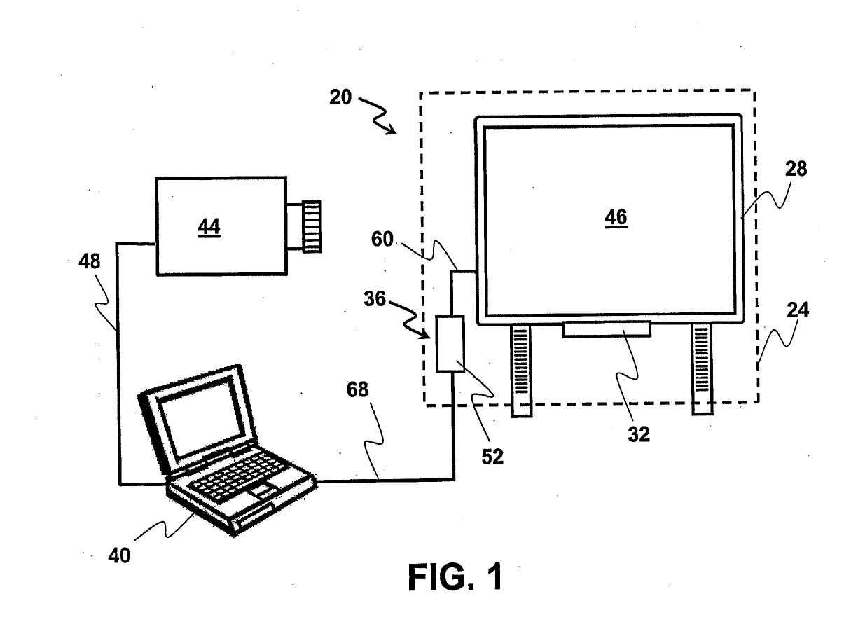

Turning now to FIG. 1, a system or network 20 of operatively connected components is illustrated. As can be seen, system 20 comprises a plug-and-play (PnP) device 24 for receiving and digitizing input. In this embodiment, the plug-and-play device 24 comprises an interactive input system that includes a touch panel 28, a controller 32 and a cable 36. Touch panel 28 may be of the type employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference. Alternatively, touch panel 28 may be of the type employing electromagnetic, capacitive, acoustic or other technologies to register pointer input. The controller 32 controls the operation of the touch panel 28 and is in communication with a computer 40 via the cable 36. The computer 40 is also connected to a projection unit 44 such as for example, a liquid crystal display (LCD) projector, via a video graphics array (VGA) cable 48 and controls the LCD projector 44. In response to image data received from the computer 40, the LCD projector 44 projects images onto a touch surface 46 of the touch panel 28. The LCD projector 44 may be positioned in front of or behind the touch panel 28.

The touch panel 28 provides a user with the ability to interact with the image projected onto the touch surface 46 of the touch panel 28 and inject input into an application program running on the computer 40 using an active pointer (e.g. a pointer that emits light, sound or other signal) or a passive pointer (e.g. a finger, cylinder or other object). Although the touch panel 28 requires no extra software other than that provided by the operating system of the computer 40 in order to work as a mouse, the functionality of the touch panel 28 can be greatly enhanced by additional software not available on the operating system of the computer 40, as will be described below.

The controller 32 comprises a processor (not shown) that executes firmware stored in non-volatile storage. Generally, the firmware causes the controller 32 to operate in one of two operational modes. In an initial mode, the controller 32 operates two USB profiles, namely an absolute mouse human interface device (“HID”) profile and a SMARTBoard HID profile. The absolute mouse HID profile enables the controller 32 to relay absolute position information for a pointer contacting the touch surface 46 of the touch panel 28 along with basic mouse functions. The SMARTBoard HID profile is a device class that enables enhanced functionality for the touch panel 28. The enhanced functionality comprises all of the functionality available in the absolute mouse HID device class as well as inking information, additional tool information (buttons, eraser, pen selection, etc.) and two-way communications with the controller 32. In a “native” operating mode, the controller 32 terminates the absolute mouse HID profile and only operates the SMARTBoard HID profile.

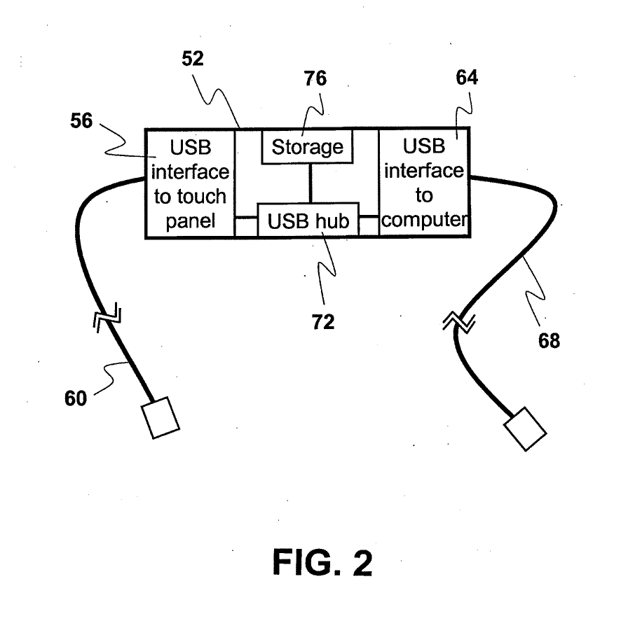

The components of the cable 36 are better illustrated in FIG. 2. As can be seen, the cable 36 comprises a USB hub component 52 having a USB interface 56 for connection to a USB cable segment 60 that extends to the touch panel 28, and a USB interface 64 for connection to a USB cable segment 68 that extends to the computer 40. Both USB interfaces 56, 64 are in communication with a USB hub 72. Also in communication with the USB hub 72 is storage 76, namely flash memory, solid-state memory or other suitable computer memory. The storage 76 is configured to operate in accordance with a mass storage device and defines itself as compact disk read only memory (CD-ROM) according to the compact disk (“CD”) HID profile. Storage 76 stores a set of software applications, including a user application (SMARTBoardTools.exe), a service application (SMARTBoardService.exe), a launcher application (SBLauncher.exe), a calibration application (SMARTBoardCalibrate.exe) and an autorun feature (autorun.inf) for a Windows® operating system file that references the launcher application. Further, the storage 76 stores calibration settings associated with the configuration of the system 20. In particular, the calibration settings include data for mapping touch coordinates generated by the touch panel 28 in response to pointer contacts with the touch surface 46 to the display coordinate system of the computer 40.

The SMARTBoardTools.exe user application permits a richer set of features than basic mouse functionality. In this embodiment, the SMARTBoardTools.exe user application contains a number of presentation applications, integration into popular drawing and presentation applications, and an application to allow users to ink over documents in any application or over the desktop of the graphical user interface of the computer 40 that is projected and displayed on the touch surface 46 of the touch panel 28.

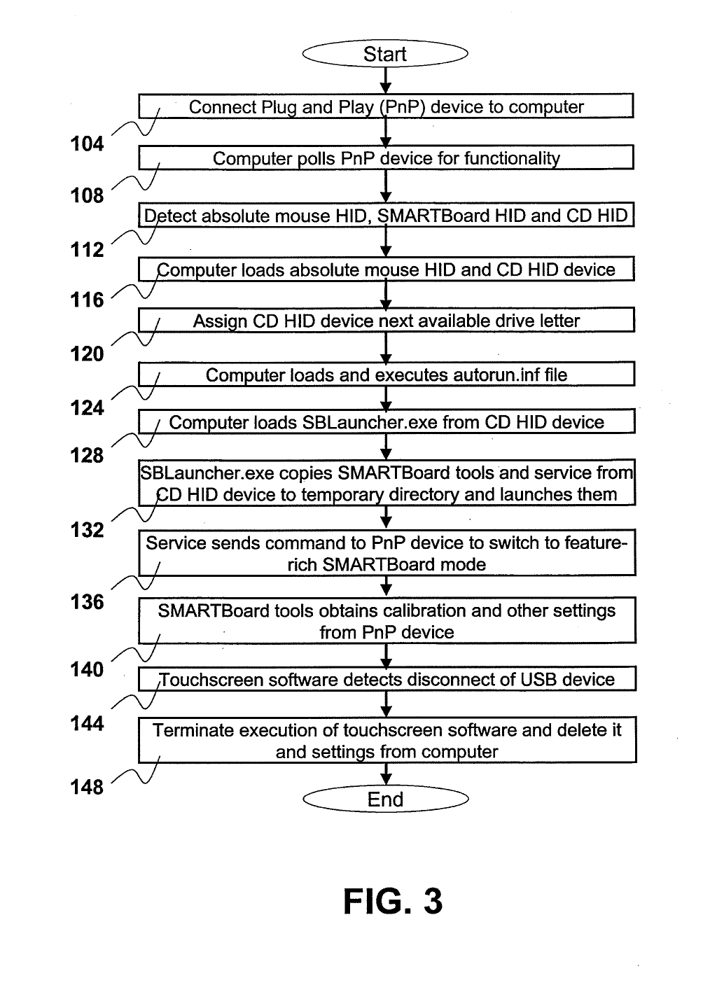

The method of operation of the plug-and-play device 24, when the plug-and-play device 24 is connected to a new computer 40 that has not been previously connected to the plug-and-play device, is shown in FIG. 3. When a session is commenced and the plug-and-play device 24 is connected to the computer 40 (step 104), and the connection of the plug-and-play device 24 to the computer 40 is detected by the operating system of the computer 40, the computer 40 queries the plug-and-play device 24 to determine what functionality is provided by the plug-and-play device 24 (step 108). As the USB hub 72 is connected to storage 76 as well as the controller 32, the USB hub 72 queries both the storage 76 and the controller 32 to determine what profiles are available. In this embodiment, the storage 76 responds by indicating that it supports the CD HID profile. The controller 32, in the initial mode, responds by indicating that it supports the absolute mouse HID profile and the SMARTBoard HID profile.

The computer 40, upon receiving the available HID profiles, detects that functionality corresponding to the absolute mouse HID profile, the SMARTBoard HID profile and CD HID profile is available (step 112). The computer 40 then loads the drivers for the devices recognized by the operating system for which the operating system has drivers, in this example the absolute mouse HID and CD HID (step 116). As each of these sets of functionality is detected by the computer 40, the computer 40 recognizes them as separate devices. The computer 40 does not load the SMARTBoard HID profile as the operating system of the computer 40 does not possess a corresponding driver. The computer 40 then assigns the plug-and-play device 24 which is recognized as a CD HID device, the next available drive letter (step 120).

Computer 40 is configured as the majority of computers are by default; that is, the computer 40 is configured to search CD HID devices for an autorun.inf file that will direct the computer 40 to automatically execute a specific application upon connection to a CD HID device. Accordingly, the computer 40 queries the plug-and-play device 24 that has been recognized as a CD HID device for an autorun.inf file and upon receiving the autorun.inf file, loads and executes the instructions contained therein (step 124). The autorun.inf file is used by the Microsoft Windows® family of operating systems to execute, under certain conditions, the instructions contained therein upon detection of certain types of storage devices. For example, under certain conditions, the autorun.inf file is executed when a CD-ROM disk, containing the autorun.inf file, is inserted into the bay of a CD-ROM drive. Execution typically begins without delay after the information in the autorun.inf file becomes available to or is recognized by the computer operating system.

The autorun.inf file contains a pointer to the executable launcher application, SBLauncher.exe. Upon parsing the autorun.inf file, the computer 40 uses the pointer to obtain the SBLauncher.exe launcher application from the storage 76, along with a set of corresponding dynamic link libraries (“DLLs”), and executes the SBLauncher.exe launcher application (step 128). The SBLauncher.exe launcher application, when executed, directs the computer 40 to copy the SMARTBoardTools.exe user application and the SMARTBoardService.exe service application, along with some associated DLLs, from the storage 76 to a temporary directory on the computer 40 and then execute the SMARTBoardTools.exe user and SMARTBoardService.exe service applications (step 132). Upon execution of the SMARTBoardService.exe service application, the SBLauncher.exe launcher application terminates execution and the SMARTBoardService.exe service application directs the computer 40 to send a command to the controller 32 to switch the controller to the SMARTBoard HID mode (step 136).

Upon launch, the SMARTBoardTools.exe user application queries and obtains from storage 76 the calibration settings and other settings (step 140). The calibration settings enable the SMARTBoardTools.exe user application to map touch input generated by the touch panel 28 in response to pointer contacts with the touch surface 46 to the display coordinate system of the computer 40. The other settings include pen tray settings, COM port settings, contact filter settings and user settings for software applications. All of these settings are stored in a standard Windows® INI file. Further, several XML files are used to store layout and menu settings for various applets forming part of the SMARTBoardTools.exe user application. These applets provide a floating window of toolbuttons for accessing various functionality, an on-screen keyboard, etc. These layout and menu settings are stored in XML files in the storage 76 of the plug-and-play device 24, and are loaded and saved in a directory (“C:\Documents and Settings\<user name>\Application Data\SMART Technologies\SMARTBoard Software\”) during execution of the SMARTBoardTools.exe user application, where <user name> is the login name of the current user.

Upon obtaining the calibration settings, the SMARTBoardTools.exe user application maps touch input generated by the touch panel 28 in response to pointer contacts with the touch surface 46 to the display coordinate system of the computer 40. In this manner, the user is able to interact effectively with the image projected onto the touch surface 46 of the touch panel 28 by the LCD projector 44. During execution, some settings are stored in the “HKEY_CURRENT_USER” key of the registry and, in particular, in the “Software\SMART Technologies\SMARTBoard Software\” subkey. These settings include application window positions, user settings for each application and a list of recently used files. The “HKEY_CURRENT_USER” key is used as there are generally no restrictions on modifications made to this key. In addition, if there are no access restrictions on the “HKEY_LOCAL_MACHINE” key, spell checker settings are written there.

Upon termination of the session, the computer 40 can be unplugged from the plug-and-play device 24 and removed. When the plug-and-play device 24 is disconnected from the computer 40, the computer 40 notifies the SBLauncher.exe launcher application (step 144). The SBLauncher.exe launcher application in turn proceeds to terminate execution of and delete the SMARTBoardTools.exe user application, the SMARTBoardService.exe service application, the various related DLLs and settings from the temporary locations on the computer 40 and then does the same for itself (step 148). Before termination of the SBLauncher.exe launcher application, the SBLauncher.exe launcher application writes the user settings stored in the “C\Documents and Settings\<user name>\Application Data\SMART Technologies Inc.\SMARTBoard Software\” directory to XML files which it then stores in storage 76 of the plug-and-play device 24. The SBLauncher.exe launcher application then deletes the user settings from the directory and those stored in the registry. Once the settings and files are deleted from the computer 40, the SBLauncher.exe launcher application places an entry in the HKEY_CURRENT_USER\Software\Microsoft\Windows\CurrentVersion\RunOnce registry key which tells Windows to delete the SBLauncher.exe launcher application when the user logs in next, and then terminates execution. If the user stops the SMARTBoard software by closing the SMARTBoardTools.exe user application, then the SBLauncher.exe launcher application executes the instance of itself found in the storage 76 of the plug-and-play device 24. Upon execution of the SBLauncher.exe launcher application instance from the plug-and-play device 24, the instance of the SBLauncher.exe launcher application stored on the computer 40 is deleted.

As noted above, in order for touch input generated by the touch panel 28 in response to pointer contacts with the touch surface 46 to be mapped to the display coordinate system of the computer 40, the system 20 is calibrated. As the spatial relation between the image projected onto the touch surface 46 of the touch panel 28 by the LCD projector 44 and the touch panel 28 changes only when the LCD projector 44 and the touch panel 28 are moved relative to one another, calibration is generally performed after the touch panel 28 and LCD projector 44 are fixed at a location. In order to calibrate the system 20, the SMARTBoardCalibrate.exe calibration application is launched. Once the SMARTBoardCalibrate.exe calibration application is launched, the user is prompted to touch a number of points on the image that is projected onto the touch surface 46 of the touch panel 28. The resulting touch panel output is used to determine calibration settings which map the raw touch coordinates generated by the touch panel 28 in response to the pointer contacts on the touch surface 46 to the display coordinate system of the computer 40. The calibration settings are then recorded in the Windows® INI file so that they can be used by other computers to map raw touch coordinates generated by the touch panel 28 in response to the pointer contacts on the touch surface 46 to the display coordinate system of the computer 40. This process allows for calibration at system installation and subsequent use of the calibration settings by all users of the system 20.

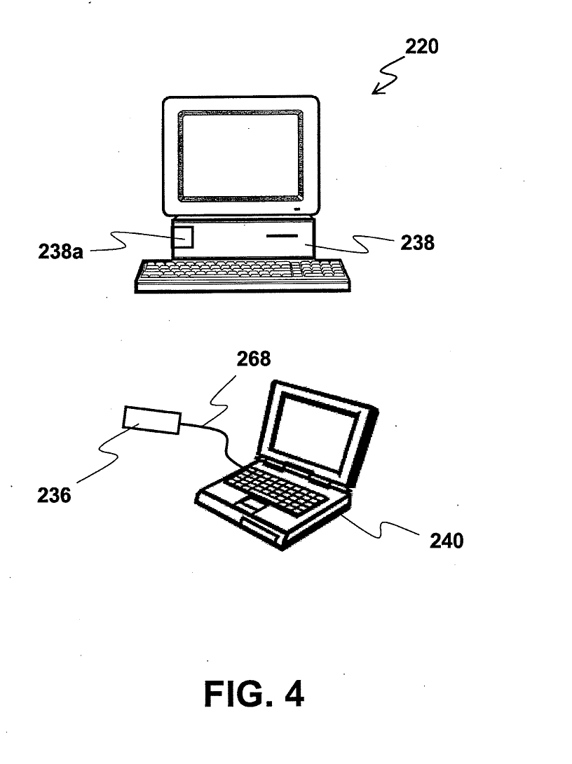

Turning now to FIG. 4, another system or network 220 of operatively connected components is shown. As can be seen, system 220 comprises a plug-and-play device 236, a master computer 238 and at least one remote computer 240. The plug-and-play device 236 is physically connected to the remote computer 240 and communicates with the master computer 238 over a wireless communications link. In this embodiment, plug-and-play device 236 captures and compresses screen display data generated at the remote computer 240 and allows screen sharing between the remote computer 240 and the master computer 238 by automatically launching software stored on the plug-and-play device 236.

In this embodiment, the master computer 238 comprises a wireless communication device 238a, for example a radio frequency (RF) communication device such as a Bluetooth™, WiFi or other RF adapter, or an infrared (IR) communication device. The master computer 238 also runs a mobile device manager software application to accept and manage connections from the remote computer 240, provide screen sharing functionality, allow remote control from the remote computer 240, and optionally, provide the remote computer 240 with Internet access.

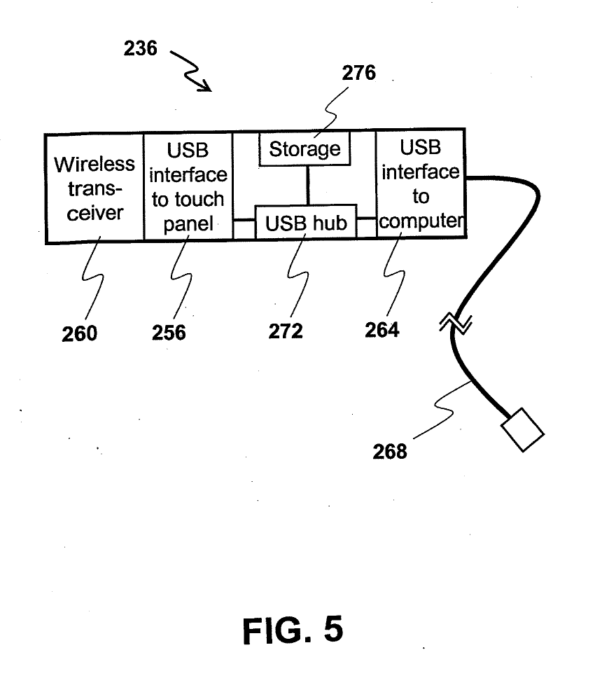

The components of the plug-and-play device 236 are better illustrated in FIG. 5. As can be seen, the plug-and-play device 236 comprises an interface 256 in the form of a USB interface to wireless communication device adapter connected to a wireless transceiver 260. Similar to wireless communication device 238a, the wireless transceiver 260 is, for example, an RF communication device such as a Bluetooth™, WiFi or other RF adapter, or an infrared (IR) communication device. The wireless communication device 238a and wireless transceiver 260 are paired to enable a peer-to-peer wireless connection between the master computer 238 and the remote computer 240 to be established. The plug-and-play device 236 also comprises an interface 264 in the form of a USB interface to computing device adapter. The interface 264 comprises a port (not shown) to receive a cable segment 268 thereby to enable the physical connection to the remote computer 240 to be made. Both interfaces 256 and 264 are also in communication with a controller 272 in the form of a USB hub.

Controller 272 also communicates with storage 276 that is configured to store and automatically launch software applications thereon via an autorun feature that the operating system of the remote computer 240 supports. Similar to the previous embodiment, storage 276 is flash memory, solid-state memory or other non-volatile computer memory. The storage 276 is configured to operate in accordance with a mass storage device and defines itself as compact disk read only memory (CD-ROM). Storage 276 stores an executable launcher application, LinQLauncher.exe and may also store one or more access codes, biometrics or keys to automatically form a secure encrypted and authenticated wireless network connection with the master computer 238.

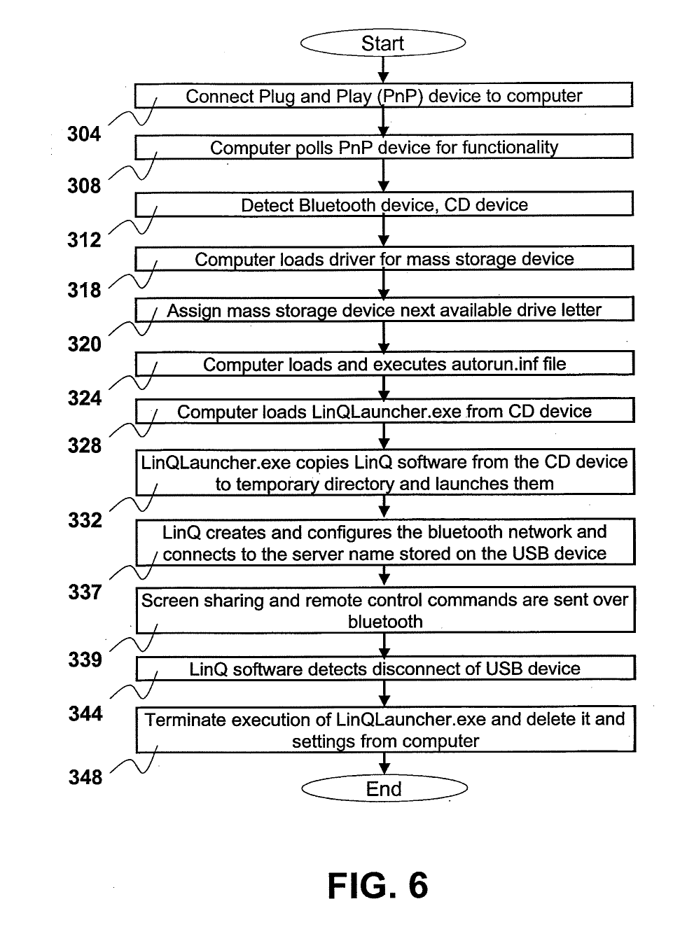

The operation of the system 220, when a peer-to-peer wireless connection between the master computer 238 and the remote computer 240 is established, will now be described with particular reference to FIG. 6. When the plug-and-play device 236 is physically connected to the remote computer 240 via the cable segment 268 (step 304) and the connection of the plug-and-play device 236 is detected by the operating system of the remote computer 240, the remote computer 240 queries the plug-and-play device 236 to determine what functionality is provided by the plug-and-play device 236 (step 308). In particular, the controller 272 queries the wireless transceiver 260 and the storage 276 to determine what profiles or connections are available. In this embodiment, the storage 276 responds by indicating that it supports the mass storage device and the wireless transceiver 260 responds by indicating its device type, interface profile and other parameters such as for example wireless network protocol, wireless network speed, encryption keys, biometrics, etc. The plug-and-play device 236 then returns the determined functionality information to the remote computer 240.

The remote computer 240, upon receiving the functionality information from the plug-and-play device 236, determines that mass storage device and wireless communications functionality for the plug-and-play device 236 is available (step 312). The remote computer 240 then loads at least the driver for the mass storage device recognized by its operating system and initializes the plug-and-play device 236 (step 316). The remote computer 240 then assigns the plug-and-play device 236 which is recognized as a mass storage device the next available drive letter (step 320).

The remote computer 240, similar to the previous embodiment, is configured as the majority of computers are by default; that is, the remote computer 240 is configured to search mass storage devices for a file name that will direct the remote computer 240 to automatically execute instructions contained therein upon connection to a mass storage device. In this embodiment, the remote computer 240 queries the plug-and-play device 236 for the autorun.inf file and upon receiving the autorun.inf file, loads and executes the instructions contained therein (step 324).

The autorun.inf file contains a pointer to the executable launcher application, LinQLauncher.exe stored in the storage 276. Upon parsing the autorun.inf file, the remote computer 240 uses the pointer to load a LinQ software application from the storage 276 (step 328). The LinQLauncher.exe application directs the remote computer 240 to copy all necessary files of the LinQ software application from storage 276 to a temporary directory on the remote computer 240 and then start the LinQ software application (step 332). The LinQ software application is used for setting up and managing the peer-to-peer wireless connection on the remote computer 240, screen sharing and communications between the remote computer 240 and the master computer 238.

Upon launch, the LinQ software application loads the necessary driver for the wireless transceiver 260, configures the wireless transceiver 260, finds the master computer 238 and establishes the peer-to-peer wireless connection between the LinQ software application and the mobile device manager application running on the master computer 238 (step 337). The LinQ software application, which manages the peer-to-peer wireless connection on the remote computer 240, then reads the access codes, biometrics or keys from the storage 276. The access codes, biometrics or keys are in turn exchanged with the master computer 238 and used as a parameter to create a secure authenticated and encrypted peer-to-peer wireless connection. The mobile device manager application running on the master computer 238 manages the peer-to-peer wireless connection on the master computer 238. In cases where multiple systems 220 may be operating, an ad-hoc network identifier may be necessary to allow the plug-and-play device 236 to determine the appropriate network to which to connect. In such cases, the ad-hoc network identifier is configured to be read from storage 276 in similar manner to the access codes, biometrics or keys.

Once the remote computer 240 is connected to the master computer 238 over the peer-to-peer wireless connection, the remote computer 240 may send a request to share the screen display data of the remote computer 240 to the master computer 238. If a request to share the screen display data is sent to the master computer 238 and accepted, the screen display data displayed on the remote computer 240 is compressed using a suitable compression algorithm such as for example MJPEG compression. The compressed screen display data is then compared with previous screen display data sent to the master computer 238 in the same peer-to-peer wireless connection session to detect differences in the screen display data. The detected differences are then sent to the master computer 238 via the peer-to-peer wireless connection and displayed on the screen of the master computer 238. The master computer 238 passes input events, such as keyboard, mouse, trackball and/or pen-touch events, that it receives to the remote computer 240 thereby to remotely control the remote computer 240 (step 339). As will be appreciated, by compressing the screen display data of the remote computer 240, the time required to transmit the screen display data to the master computer 238 is reduced. Also, compressing the screen display data and only transmitting differences between screen display data, reduces the amount of screen display data that needs to be transmitted to the master computer 238 during screen sharing. This of course reduces the required transmission bandwidth required for screen sharing and thus, decreases latency.

When the peer-to-peer wireless connection is established between the master computer 238 and the remote computer 240, those skilled in the art will appreciate that, besides sharing the screen display data of the remote computer 240, file sharing between the master computer 238 and the remote computer 240 can also be carried out. To share files stored on the master computer 238, one or more shared directories are set up on the master computer 238 with appropriate access right settings for the user of the remote computer 240. The user of the remote computer 240 can then open the shared directories and access the files therein. Alternatively, shared directories can also be set up on the remote computer 240 with appropriate access right settings for the user of the master computer 238 and/or for users of other remote computers 240. The user of the master computer 238 or other remote computer 240 can similarly open the shared directories and access the files therein. Further, the LinQLauncher.exe application can be configured to send files directly to and from the master and other remote computers 238 and 240 respectively.

With the peer-to-peer wireless connection established between the master computer 238 and the remote computer 240, those skilled in the art will appreciate that the user of the remote computer 240 may also be allowed to access the Internet through the master computer 238. To enable Internet access, the master computer 238 must be connected to the Internet via a wired or wireless local area network, dial-up network or other suitable type of network. With Internet access granted by the master computer 238, Internet access requests initiated by the remote computer 240 are transmitted to the master computer 238 over the peer-to-peer wireless connection. The master computer 238 in response to received Internet access requests sends the received Internet access requests either directly to the Internet or indirectly to the Internet via a proxy server. Responses returned from the Internet that are received directly by the master computer 238 or indirectly by the master computer 238 from the proxy server are returned to the remote computer 240 over the peer-to-peer wireless connection.

Upon termination of the session between the remote computer 240 and the master computer 238, the plug-and-play device 236 can be unplugged from the remote computer 240 and removed. When the plug-and-play device 236 is disconnected from the remote computer 240, the remote computer 240 notifies the LinQLauncher.exe application (step 344). The LinQLauncher.exe application in turn stops the screen sharing, disconnects the peer-to-peer wireless connection with the master computer 238, terminates the execution of the LinQ software application, deletes the files in the temporary directory on the remote computer 240 that were copied from the storage 276, and then terminates the execution of itself (step 348). Those skilled in the art will appreciate that other clean up tasks, such as removing items in the system registry that were written by the LinQ software application when it was launched may also be performed upon the disconnection of the plug-and-play device 236 from the remote computer 240.

Although FIG. 4 shows the master computer 238 communicating with a single remote computer 240 over a peer-to-peer wireless connection, those of skill in the art will appreciate that this is simply for ease of illustration and that the master computer 238 may communicate with a plurality of remote computers 240 over peer-to-peer wireless connections via respective plug-and-play interfaces 236. In situations where the master computer 238 is communicating with multiple remote computers 240 over peer-to-peer wireless connections, compressed screen display data transmitted by one remote computer 240 to the master computer 238 may also be shared by the master computer 238 with one or more other remote computers 240. In addition, if a remote computer 240 establishes a connection to the master computer 238 over a peer-to-peer wireless connection and a peer-to-peer wireless connection between the master computer 238 and another remote computer 240 already exists over which screen display data is being shared, the master computer 238 can automatically share the screen display data with the newly connected remote computer 240. Control commands initiated on the newly connected remote computer 240 that are sent to the master computer 238 may be sent to the remote computer that is sharing its screen display data to remotely manipulate its operation provided that remote computer has enabled remote control.

Although the remote computer 240 is described as loading the wireless transceiver driver at step 328 when the LinQLauncher.exe application is loaded from storage 276, if desired, the driver for the wireless transceiver 260 may be loaded at step 318 when the driver for the plug-and-play device 236 which is recognized as a mass storage device is being loaded.

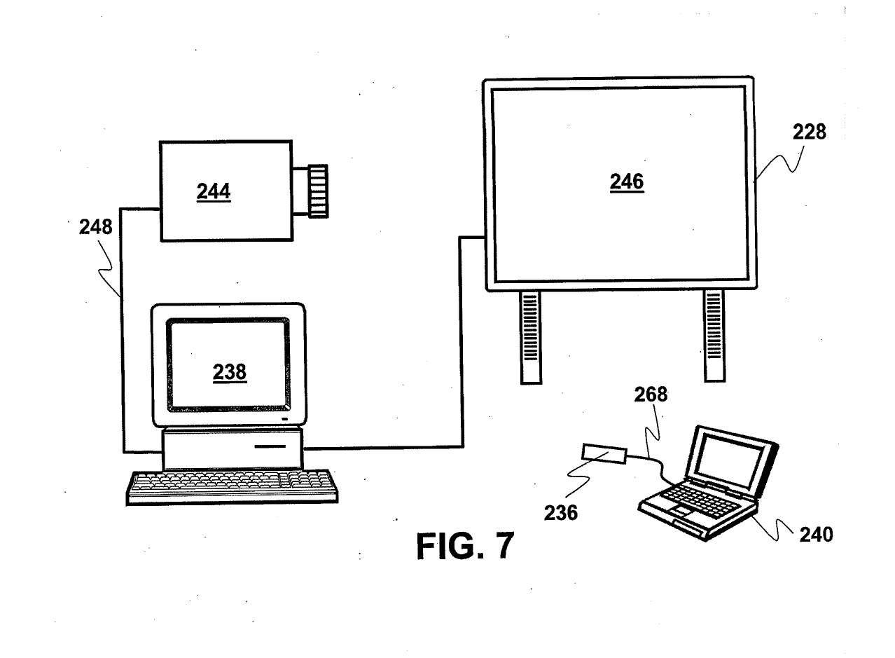

Similar to the embodiment of FIG. 3, if desired, the master computer 238 can be connected to an interactive input system 228 of one of the types described previously as shown in FIG. 7. In this case, shared screen display data received by the master computer 238 can be presented on the touch surface 246 of the interactive input system 228 via a projection device 244 that is connected to the master computer 238 by a physical cable 248 allowing a user to interact with the shared screen display data through pointer contacts with the touch surface 246.

Those of skill in the art will appreciate that the physical form of the plug-and-play device 236 may be changed. For example, although the plug-and-play device 236 is shown as being connected to the remote computer 240 via cable segment 268, the plug-and-play device 236 alternatively may take the form of a dongle similar to a USB flash drive or the like that plugs directly into the remote computer 240.

In the above embodiment, rather than establishing a peer-to-peer wireless connection, alternatively, the LinQ software application may be configured to direct the remote computer 240 to use its wireless network card to establish a wireless connection between the remote computer 240 and the master computer 238 over existing network infrastructure.

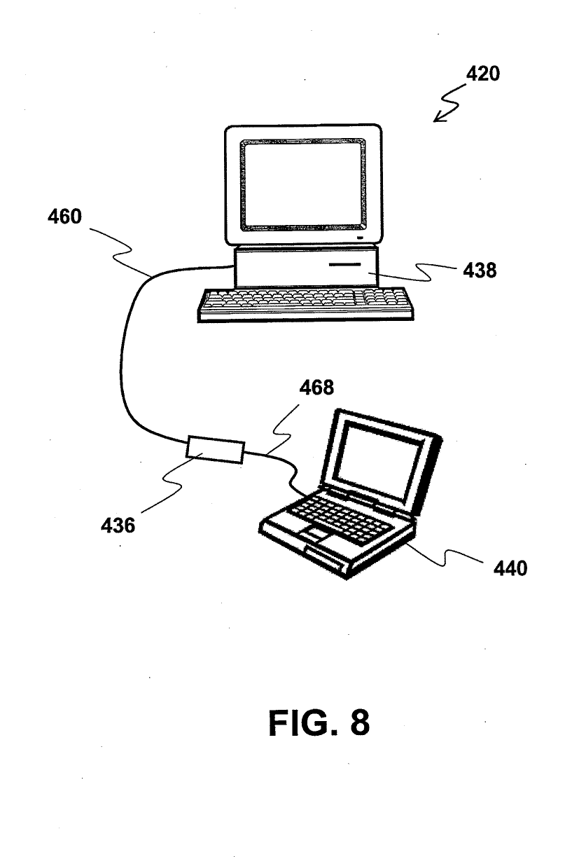

FIG. 8 illustrates yet another embodiment of a system or network 420 of operatively connected components. Similar to the embodiment of FIG. 4, system 420 comprises a plug-and-play device 436, a master computer 438 and at least one remote computer 440. The plug-and-play device 436 is physically connected to both the remote computer 440 and the master computer 438. The plug-and-play device 436 enables bi-directional transmission of screen display and remote control data in real-time between the master computer 438 and remote computer 440 by automatically launching software stored on the plug-and-play device 436.

The master computer 438, similar to the previous embodiment, runs a mobile device manager application to accept and manage connections from the remote computer 440, provide bi-directional screen sharing functionality, allow remote control from the remote computer 440, and optionally, provide the remote computer 440 with Internet access.

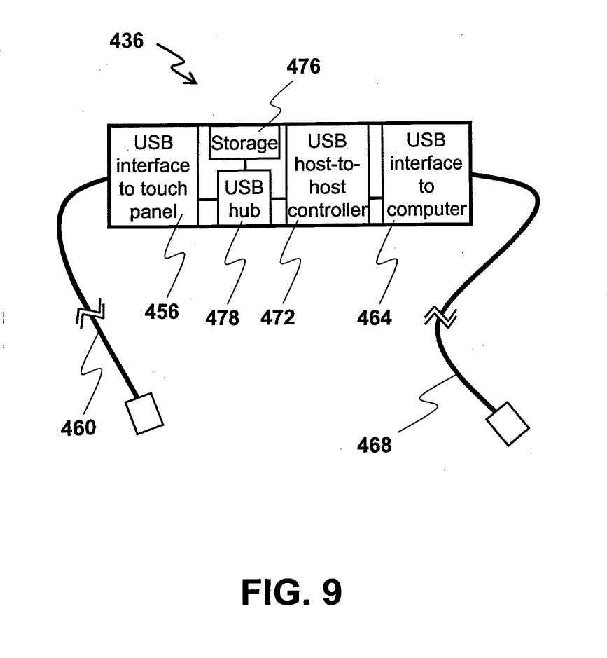

The components of the plug-and-play device 436 are better illustrated in FIG. 9. As can be seen, the plug-and-play device 436 comprises an interface 456 in the form of a USB interface to computing device adapter and an interface 464 also in the form of a USB interface to computing device adapter. The interface 456 comprises a port (not shown) to receive a cable segment 460 that extends and connects to the master computer 438. The interface 464 also comprises a port (not shown) to receive a cable segment 468 that extends and connects to the remote computer 440. The plug-and-play device 436 also comprises a controller 472 in the form of a USB host-to-host controller, and a USB hub 478. The USB host-to-host controller 472 allows bi-direction screen data sharing in real-time between the remote computer 440 and the master computer 438. The interface 456 is in communication with the USB hub 478 and the interface 464 is in communication with the USB host-to-host controller 472. The USB hub 478 communicates with the USB host-to-host controller 472.

Also in communication with the USB hub 478 is storage 476, for example flash memory, solid-state memory or other suitable computer memory. The storage 476 is configured to store and automatically launch software applications thereon via an autorun feature that the operating system of the remote computer 440 supports. The storage 476 is configured to operate in accordance with a mass storage device that defines itself as a CD ROM. Similar to the previous embodiment, storage 476 stores the executable LinQLauncher.exe application.

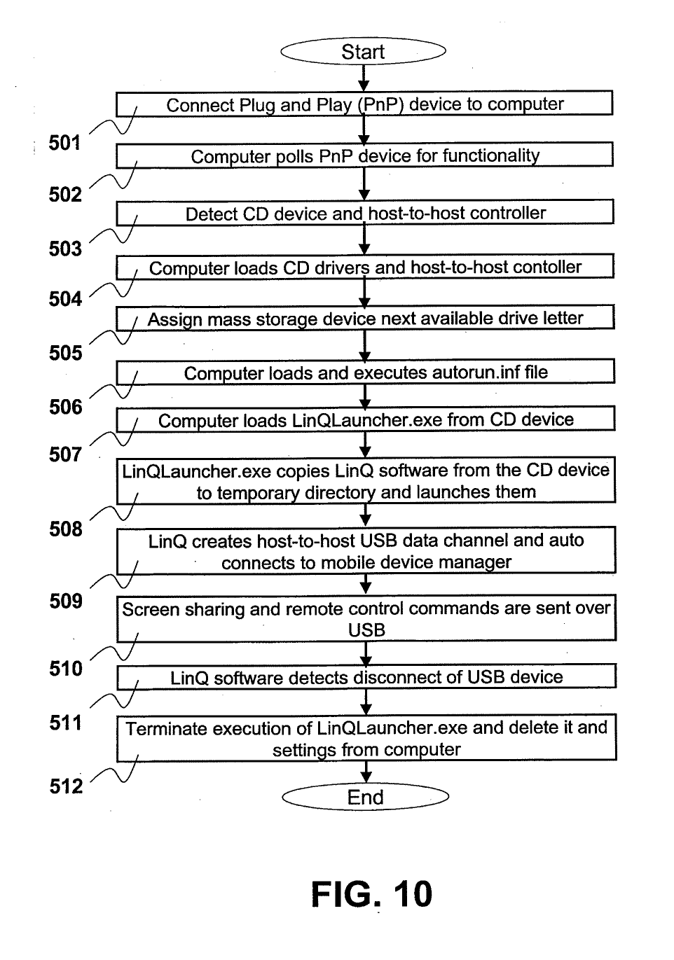

The operation of the system 440 when a connection between the master computer 438 and the remote computer 440 via the plug-and-play device 436 is established will now be described with particular reference to FIG. 10. When the plug-and-play device 436 is physically connected to the remote computer 440 via the cable segment 468 (step 501) and the connection of the plug-and-play device 436 is detected by the operating system of the remote computer 440, the remote computer 440 queries the plug-and-play device 436 to determine what functionality is provided by the plug-and-play device 436 (step 502). In response to this query, the plug-and-play device 436 determines that it supports the mass storage device and USB host-to-host controller and returns this functionality information to the remote computer 440.

The remote computer 440, upon receiving the functionality information from the plug-and-play device 436, determines that mass storage device and USB host-to-host controller functionality for the plug-and-play device 436 is available (step 503). The remote computer 440 then loads at least the driver for the mass storage device recognized by its operating system and initializes the plug-and-play device 436 (step 504). The remote computer 440 then assigns the plug-and-play device 436 which is recognized as a mass storage device, the next available drive letter (step 505).

The remote computer 440, similar to the previous embodiments, is configured as the majority of computers are by default; that is, the remote computer 440 is configured to search the mass storage devices for a file name that will direct the remote computer 440 to automatically execute instructions contained therein upon connection to the mass storage device. In this embodiment, the remote computer 440 queries the plug-and-play device 436 for the autorun.inf file and upon receiving the autorun.inf file, loads and executes the instructions contained therein (step 506).

The autorun.inf file contains a pointer to the executable launcher application, LinQLauncher.exe stored in storage 476. Upon parsing the autorun.inf file, the remote computer 440 uses the pointer to load a LinQ software application from the storage 476 (step 507). The LinQLauncher.exe application directs the remote computer 440 to copy all necessary files of the LinQ software application from storage 476 to a temporary directory on the remote computer 440 and then start the LinQ software application (step 508). The LinQ software application is used for setting up and managing the connection on the remote computer 440, screen sharing and other communications between the remote computer 440 and the master computer 438.

In this embodiment, the mass storage device functionality of the plug-and-play device 436 is only exposed to the remote computer 440. The mobile device manager software application running on the master computer 438 detects the insertion of cable segment 460 and communicates with it through a pre-installed driver on the master computer 438.

Upon launch, the LinQ software application on the remote computer 440 finds the master computer 438 and establishes a USB host-to-host data channel between the remote computer 440 and master computer 438 and automatically connects to the mobile device manager software application running on the master computer 438 (step 509). The mobile device manager software application running on the master computer 438 manages the connection on the master computer 438.

Once the remote computer 440 is connected to the master computer 438, the remote computer 440 may send a request to share the screen display data of the remote computer 440 with the master computer 438. If a request to share the screen display data is sent to the master computer 438 and accepted, the screen display data of the remote computer 440 is compressed, sent to the master computer 438 and displayed on the screen of the master computer 438. The master computer 438 passes input events, such as keyboard, mouse, trackball and/or pen-touch events, that it receives to the remote computer 440 thereby to remotely control the remote computer 440 (step 510). As mentioned previously, the advantage of compressing the screen display data of the remote computer 440 before sending it to the master computer 438 is that the amount of data required to be transmitted to the master computer 438 is reduced. This of course reduces the transmission bandwidth and latency required for screen sharing.

If at the time the remote computer 440 is connected to the master computer 438 and another remote computer 440 in the network is sharing its screen display data with the master computer 438, the remote computer 440 automatically receives the compressed screen display data from the master computer 438, decompresses it and displays it on its display screen. Also, control commands initiated on the other remote computer 440 may be sent to the master computer 438 and then to the remote computer 440 to enable operation of the remote computer 440 to be remotely controlled provided the remote computer has enabled remote control.

If desired, the remote computer 440 can be configured to display the master computer desktop image on its display screen and pass input events, such as keyboard, mouse, trackball and/or pen-touch events that it receives to the master computer 438 to remotely control the master computer 438 provided the master computer has enabled remote control.

When the connection is established between the master computer 438 and the remote computer 440, those skilled in the art will appreciate that, besides sharing the screen display data of the remote computer 440, file sharing between the master computer 438 and the remote computer 440 can also be carried out. To share files stored on the master computer 438, one or more shared directories are set up on the master computer 438 with appropriate user access right settings for the user of the remote computer 440. The user of the remote computer 440 can then open the shared directories and access the files therein. Alternatively, shared directories can also be set up on the remote computer 440 with appropriate access right settings for the user of the master computer 438 and/or for users of other remote computers 440.

With the connection established between the master computer 438 and the remote computer 440, those skilled in the art will appreciate that the user of the remote computer 440 may also be allowed to access Internet through the master computer 438. To enable the Internet access, the master computer 438 must be connected to the Internet via a wired or wireless local area network, dial-up network or any other type of network. With the allowance of Internet access granted by the user of the master computer 438, Internet access requests initiated by the remote computer 440 are transferred to the master computer 438. Responses returned from the Internet that are received directly by the master computer 438 or indirectly by the master computer 438 from the proxy server are returned to the remote computer 440.

Upon termination of the session between the remote computer 440 and the master computer 438, the plug-and-play device 436 can be unplugged from the remote computer 440 and removed. When the plug-and-play device 436 is disconnected from the remote computer 440, the remote computer 440 notifies the LinQLauncher.exe application (step 511). The LinQLauncher.exe application in turn stops the screen sharing, disconnects the connection with the master computer 438, terminates the execution of the LinQ software application, deletes the files in the temporary directory on the remote computer 440 that were copied from the storage 476, and then terminates the execution of itself (step 512). Those skilled in the art will appreciate that other clean up tasks, for example removing items in the system registry that were written by the LinQ software application when it was launched, may be performed upon the disconnection of the plug-and-play device 436 from the remote computer 440.

In an alternative embodiment, the mass storage device functionality of the plug-and-play device 36 is exposed to both the master and remote computers 438 and 440 so that the LinQ software application is automatically launched on both the master and remote computers 438 and 440 respectively. Because the mobile device manager software application is running on the master computer 438, the LinQ software application launched on the master computer 438 closes itself so the mobile device manager software can communicate with the USB host-to-host controller 472. Upon launch of the LinQ software application on the remote computer 440, the LinQ software application finds the master computer 438 and establishes the USB host-to-host data channel and automatically connects to the mobile device manager software application running on the master computer 438 (step 309). The mobile device manager software application running on the master computer 438 manages the connection on the master computer 438.

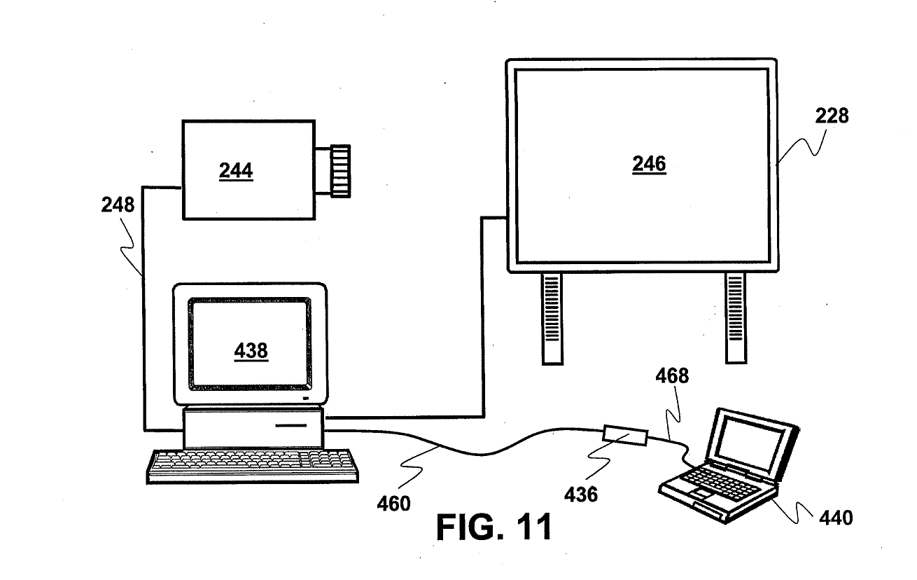

Similar to the previous embodiments, if desired, the master computer 438 can be connected to an interactive input system 228 of one of the types described previously as shown in FIG. 11. In this case, shared screen display data received by the master computer 438 can be presented on the touch surface 246 of the interactive input system 228 via a projection device 244 that is connected to the master computer 438 by a physical cable 248 allowing a user to interact with the shared screen display data through pointer contacts with the touch surface 246.

In the embodiments described above, the computers are described as using the autorun.inf file to perform auto-execution. Those of skill in the art will appreciate that other auto-execution methods such as for example Autoplay may be employed.

In the embodiments where the plug-and-play devices use cable segments to connect to the remote computers and master computers, if desired, the cable segments may be retractably accommodated by the plug-and-play devices.

In the embodiments of FIGS. 4 to 11, rather than carrying out Internet connections over the connections between the remote computers and master computers, if desired, the remote computers may be directed to use their wireless network cards to establish an Internet connection over existing network infrastructure.

While the systems have been described with specificity to USB, other types of plug-and-play architectures can be utilized. For example, those of skill in the art will readily understand how to adapt the systems described herein for use with FireWire and PCMCIA architectures and the like.

While embodiments have been described with reference to a touch panel, the system can be any one of a number of other devices, such as cameras, sound systems, mice, keyboards, printers, displays, etc. For example, where the plug-and-play device is a sound system, the settings can include the output volumes for each speaker that has been previously calibrated to desired levels for the set configuration.

While an LCD projector has been described as projecting image data on the touch panel, those of skill in the art will appreciate that other devices such as with an LCD displays, plasma displays, cathode ray tubes, or other display devices known to those of skill in the art may be used to generate images that are presented on the touch panel.

Although embodiments have been described with reference to the accompanying drawings, those of skill in the art will appreciate that modifications and variations may be made without departing from the spirit and scope thereof as defined by the appended claims.

What is claimed is:

1. A plug-and-play device comprising:
a first plug-and-play interface for establishing a connection with a first computing device;
a second plug-and-play interface for establishing a connection with a second computing device;
storage storing code that is automatically executed by the second computing device when said plug-and-play device is connected to said second computing device via said second plug-and-play interface, said code when executed by said second computing device initiating a screen display data exchange between said first and second computing devices through said plug-and-play device; and
at least one controller controlling said first plug-and-play interface, said second plug-and-play interface and said storage.

2. The plug-and-play device of claim 1 wherein the first plug-and-play interface comprises a wireless transceiver and wherein the first plug-and-play interface establishes a wireless connection with said first computing device.

3. The plug-and-play device of claim 2 wherein said wireless connection is a secure wireless connection.

4. The plug-and-play devive of claim 3 wherein said storage further stores at least one of at least one key, at least one biometric and at least one code used to establish said secure wireless connection.

5. The plug-and-play device of claim 2 wherein the second plug-and-play interface receives a physical connection extending to said second computing device.

6. The plug-and-play device of claim 5 wherein said physical connection is a universal serial bus (USB) cable.

7. The plug-and-play device of claim 2 further comprising a physical connection to said second computing device.

8. The plug-and-play device of claim 7 wherein said physical connection is a USB cable.

9. The plug-and-play device of claim 7 wherein said wireless connection is a secure wireless connection.

10. The plug-and-play device of claim 2 wherein the plug-and-play device is configured as a dongle to plug into a port of said second computing device.

11. The plug-and-play device of claim 10 wherein said wireless connection is a secure wireless connection.

12. The plug-and-play device of claim 2 wherein the storage is non-volatile memory.

13. The plug-and-play device of claim 2 wherein the at least one controller is a USB hub.

14. The plug-and-play device of claim 13 further comprising a physical connection to said second computing device.

15. The plug-and-play device of claim 14 wherein said wireless connection is a secure wireless connection.

16. The plug-and-play device of claim 13 wherein the plug-and-play device is configured as a dongle to plug into a port of said second computing device.

17. The plug-and-play device of claim 16 wherein said wireless connection is a secure wireless connection.

18. The plug-and-play device of claim 1 wherein said screen display data exchange comprises transmission of second computing device display screen data to said first computing device.

19. The plug-and-play device of claim 18 wherein the second computing device display screen data is compressed prior to transmission to said first computing device.

20. The plug-and-play device of claim 19 wherein differences between previously transmitted second computing device display screen data and current second computing device display screen data are transmitted.

21. The plug-and-play device of claim 1 wherein said screen display data exchange comprises transmission of first computing device display screen data to said second computing device.

22. The plug-and-play device of claim 21 wherein the first computing device display screen data is compressed prior to transmission to said second computing device.

23. The plug-and-play device of claim 24 wherein differences between previously transmitted first computing device display screen data and current first computing device display screen data are transmitted.

24. The plug-and-play device of claim 18 wherein the code when executed further permits file sharing between said first and second computing devices through said plug-and-play device.

25. The plug-and-play device of claim 21 wherein the code when executed further permits file sharing between said first and second computing devices through said plug-and-play device.

26. The plug-and-play device of claim 2 wherein said screen display data exchange comprises transmission of second computing device display screen data to said first computing device.

27. The plug-and-play device of claim 26 wherein the second computing device display screen data is compressed prior to transmission to said first computing device.

28. The plug-and-play device of claim 27 wherein differences between previously transmitted second computing device display screen data and current second computing device display screen data are transmitted.

29. The plug-and-play device of claim 2 wherein said screen display data exchange comprises transmission of first computing device display screen data to said second computing device.

30. The plug-and-play device of claim 29 wherein the first computing device display screen data is compressed prior to transmission to said second computing device.

31. The plug-and-play device of claim 30 wherein differences between previously transmitted first computing device display screen data and current first computing device display screen data are transmitted.

32. The plug-and-play device of claim 7 wherein said screen display data exchange comprises transmission of second computing device display screen data to said first computing device.

33. The plug-and-play device of claim 32 wherein compresses the second computing device display screen data is compressed prior to transmission to said first computing device.

34. The plug-and-play device of claim 33 wherein differences between previously transmitted second computing device display screen data and current second computing device display screen data are transmitted.

35. The plug-and-play device of claim 7 wherein said screen display data exchange comprises transmission of first computing device display screen data to said second computing device.

36. The plug-and-play device of claim 35 wherein the first computing device display screen data is compressed prior to transmission to said second computing device.

37. The plug-and-play device of claim 38 wherein differences between previously transmitted first computing device display screen data and current first computing device display screen data are transmitted.

38. The plug-and-play device of claim 1 wherein the first plug-and-play interface receives a physical connection extending to said first computing device and wherein the second plug-and-play interface receives a physical connection extending to the second computing device.

39. The plug-and-play device of claim 38 wherein each physical connection is a USB cable.

40. The plug-and-play device of claim 1 further comprising a physical connection to said first computing device and a physical connection to said second computing device.

41. The plug-and-play device of claim 40 wherein each physical connection is a USB cable.

42. The plug-and-play device of claim 40 wherein said screen display data exchange comprises transmission of second computing device display screen data to said first computing device.

43. The plug-and-play device of claim 42 wherein the second computing device display screen data is compressed prior to transmission to said first computing device.

44. The plug-and-play device of claim 43 wherein differences between previously transmitted second computing device display screen data and current second computing device display screen data are transmitted.

45. The plug-and-play device of claim 40 wherein said screen display data exchange comprises transmission of first computing device display screen data to said second computing device.

46. The plug-and-play device of claim 45 wherein the first computing device display screen data is compressed prior to transmission to said second computing device.

47. The plug-and-play device of claim 46 wherein differences between previously transmitted first computing device display screen data and current first computing device display screen data are transmitted.
